(19) United States
(12) Patent Application Publication
(10) Pub. No.: US 2024/0346461 A1
(43) Pub. Date: Oct. 17, 2024

(54) METHODS AND INTERNET OF THINGS SYSTEMS FOR MANAGING ROBOTS IN PIPELINE CORRIDOR OF GAS BASED ON REGULATORY INTERNET OF THINGS

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Zhubin CHENG, Chengdu (CN); Lilong SU, Chengdu (CN)

(73) Assignee: CHENGDU QINCHUAN IOT TECHNOLOGY CO., LTD., Chengdu (CN)

(21) Appl. No.: 18/751,292

(22) Filed: Jun. 23, 2024

(30) Foreign Application Priority Data
Apr. 26, 2024 (CN) 202410508743.3

(51) Int. Cl. G06Q 10/20; G05B 19/4155; G06Q 50/26

(52) U.S. Cl. CPC G06Q 10/20; G05B 19/4155; G06Q 50/26; G05B 2219/50391

(57) ABSTRACT

A method for managing a gas pipeline corridor robot based on regulatory Internet of Things (IoT) is disclosed, the method comprises: obtaining corridor environmental data from a sensing network platform of the gas company; determining a robot inspection command based on the corridor environmental data; sending the robot inspection command to a gas equipment object platform via the sensing network platform of the gas company; obtaining inspection data of the maintenance robot; determining doubtful data based on the inspection data; in response to the presence of the doubtful data, transmitting the doubtful data to a gas customer service platform for manual re-inspection; and obtaining a manual re-inspection result and uploading the manual re-inspection result to a government supervision management platform via a government supervision sensing network platform.

### CROSS-REFERENCE TO RELATED APPLICATIONS

This application claims priority to Chinese Patent Application No. 202410508743.3, filed on Apr. 26, 2024, the entire contents of which are hereby incorporated by reference.

### TECHNICAL FIELD

The present disclosure relates to a field of monitoring a comprehensive pipeline corridor, and in particular, to a method and an Internet of Things (IoT) system for managing a gas pipeline corridor robot based on regulatory IoT.

### BACKGROUND

Comprehensive pipeline corridor robots are widely used in gas leak monitoring and fire hazard identification inside pipelines. However, for the corrosion and aging of facilities and equipment inside the pipeline corridor, as well as the replacement of consumables, it is still necessary to collect corresponding image data and environmental data, relying on manual identification and judgment, which is less efficient. Additionally, due to the varying degree of rigor in manual inspection, there may be omissions in inspection, resulting in potential safety hazards.

To address the issue of possible omissions due to variations in the rigor of manual inspections, Patent CN107632581B proposes a monitoring and management system for underground pipeline corridors. The system utilizes an inspection robot to inspect predefined items in the underground pipeline corridor, and reports real-time data obtained from the inspection to a data analysis and evaluation system, thereby realizing automated monitoring and real-time reporting of data. However, the system still lacks effective technical means in the replacement of consumables in different regions of the pipeline corridor based on the data collected by the robot, as well as the evaluation of manual maintenance cycles.

Therefore, it is desired to provide a method and an IoT system for managing a gas pipeline corridor robot based on regulatory Internet of Things, in order to realize full-aspect automated monitoring of the facilities inside the comprehensive pipeline corridor, so as to improve the efficiency of the robotic inspection, reduce the safety hazards, and provide a more reliable guarantee for the operation of the comprehensive pipeline corridor to provide more reliable protection.

### SUMMARY

One or more embodiments of the present disclosure provide a method for managing a gas pipeline corridor robot based on regulatory Internet of Things (IoT), the method being performed by a management platform of a gas company of an IoT system for managing the gas pipeline corridor robot based on the regulatory IoT, comprising: obtaining, through the management platform of the gas company, corridor environmental data from a sensing network platform of the gas company; determining, through the management platform of the gas company, a robot inspection command based on the corridor environmental data; sending, through the management platform of the gas company, the robot inspection command to a gas equipment object platform via the sensing network platform of the gas company to control a maintenance robot to operate along an operation track; obtaining inspection data of the maintenance robot, through the management platform of the gas company; determining, through the management platform of the gas company, doubtful data based on the inspection data; in response to the presence of the doubtful data, transmitting, through the management platform of the gas company, the doubtful data to a gas customer service platform for manual re-inspection; and obtaining a manual re-inspection result and uploading the manual re-inspection result to a government supervision management platform via a government supervision sensing network platform, through the management platform of the gas company.

One or more embodiments of the present disclosure provide an IoT system for managing a gas pipeline corridor robot based on regulatory IoT, comprising a government supervision service platform, a government supervision management platform, a government supervision sensing network platform, a gas customer service platform, a government supervision object platform, a sensing network platform of the gas company, and a gas equipment object platform; the government supervision service platform includes a government safety supervision service platform; the government supervision management platform includes a government safety supervision management platform; the government supervision sensing network platform includes a government safety supervision sensor network platform; the government supervision object platform includes the management platform of the gas company; the government supervision sensing network platform is configured to interact with the government supervision management platform and the government supervision object platform; the sensing network platform of the gas company is configured to interact with the management platform of the gas company and the government supervision object platform; the gas customer service platform is configured to interact with the management platform of the gas company; the management platform of the gas company is configured to: obtain, through the management platform of the gas company, corridor environmental data from a sensing network platform of the gas company;

determine, through the management platform of the gas company, a robot inspection command based on the corridor environmental data; send, through the management platform of the gas company, the robot inspection command to a gas equipment object platform via the sensing network platform of the gas company to control a maintenance robot to operate along an operation track; obtain inspection data of the maintenance robot, through the management platform of the gas company; determine, through the management platform of the gas company, doubtful data based on the inspection data; in response to the presence of the doubtful data, transmit, through the management platform of the gas company, the doubtful data to a gas customer service platform for manual re-inspection; and obtain a manual re-inspection result and uploading the manual re-inspection result to a government supervision management platform via a government supervision sensing network platform, through the management platform of the gas company.

One or more embodiments of the present disclosure provide a non-transitory computer-readable storage medium, comprising a set of instructions, wherein when a computer reads the computer instructions in the storage medium, a method for managing a gas pipeline corridor robot based on regulatory IoT is implemented.

### BRIEF DESCRIPTION OF THE DRAWINGS

This description will be further explained in the form of exemplary embodiments, which will be described in detail by means of accompanying drawings. These embodiments are not restrictive, in which the same numbering indicates the same structure, wherein:

FIG. 1 is an exemplary schematic diagram illustrating an IoT system for managing a gas pipeline corridor robot based on regulatory Internet of Things according to some embodiments of the present disclosure;

FIG. 2 is an exemplary flowchart illustrating a process for managing a gas pipeline corridor robot based on regulatory Internet of Things, according to some embodiments of the present disclosure;

FIG. 3 is an exemplary flowchart illustrating a process for determining doubtful data according to some embodiments of the present disclosure;

FIG. 4 is an exemplary schematic diagram illustrating a process for adjusting a replacement cycle according to some embodiments of the present disclosure;

FIG. 5 is an exemplary diagram illustrating a hazard determination model according to some embodiments of the present disclosure;

FIG. 6 is an exemplary flowchart illustrating a process for adjusting a replacement cycle according to some embodiments of the present disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the “system,” “device”, “unit” and/or “module” used herein is a method for distinguishing different components, elements, components, parts or assemblies of different levels. However, if other words may achieve the same purpose, the words may be replaced by other expressions.

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

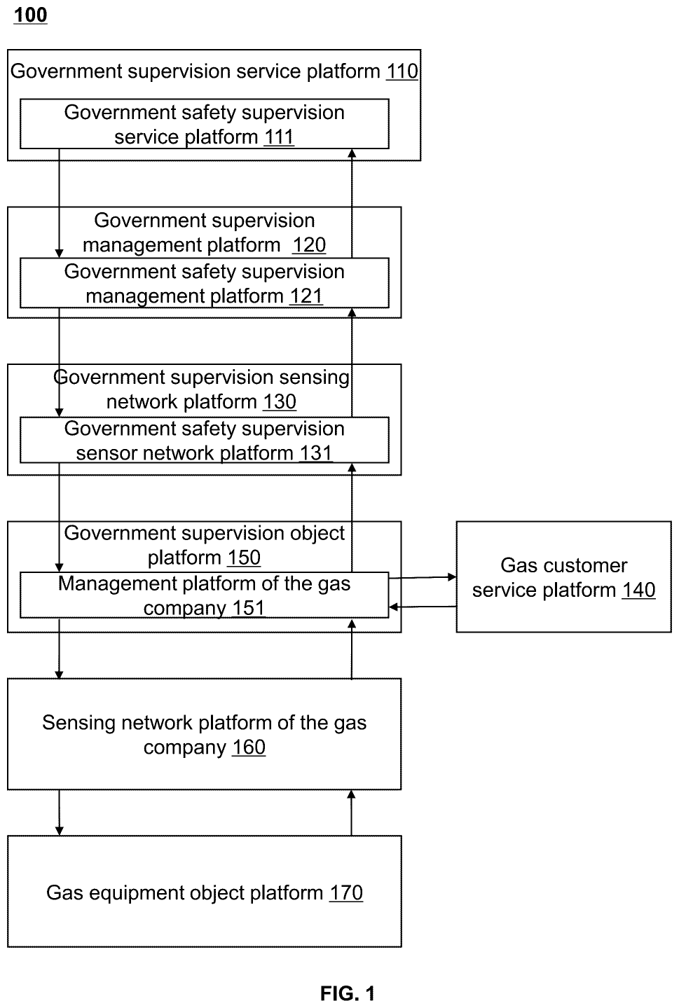

FIG. 1 is an exemplary schematic diagram illustrating an IoT system for managing a gas pipeline corridor robot based on regulatory Internet of Things according to some embodiments of the present disclosure. It should be noted that the following embodiments are only used for explaining the present disclosure and do not constitute a limitation of the present disclosure.

As shown in FIG. 1, the IoT system 100 for managing the gas pipeline corridor robot based on the regulatory Internet of Things may include a government supervision service platform 110, a government supervision management platform 120, a government supervision sensing network platform 130, a gas customer service platform 140, a government supervision object platform 150, a sensing network platform of the gas company 160, and a gas equipment object platform 170.

The government supervision service platform 110 may be a platform that provides regulatory services for a government. In some embodiments, the government supervision service platform 110 may include a governmental safety supervision service platform 111. The governmental safety supervision service platform 111 may be a platform that provides safety regulatory services for the government.

The government supervision management platform 120 may be a platform for the government to conduct regulatory management. In some embodiments, the government supervision management platform 120 may include a governmental safety supervision management platform 121. The governmental safety supervision management platform 121 may be a platform for the government to perform safety supervision and management.

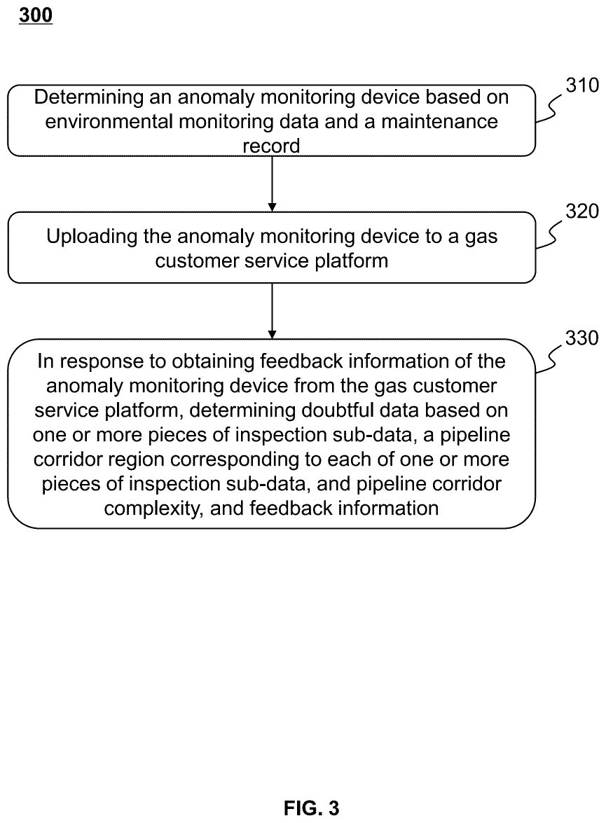

In some embodiments, the governmental safety supervision management platform 121 may be used to obtain a maintenance record of a pipeline corridor monitoring device, and more descriptions of this section may be found in FIG. 3 and its related descriptions.

The government supervision sensor network platform 130 may be a functional platform for managing supervision-related information. In some embodiments, the government supervision sensing network platform 130 may include a governmental safety supervision sensor network platform 131. The government safety supervision sensor network platform 131 may serve as a functional platform for managing information related to safety supervision.

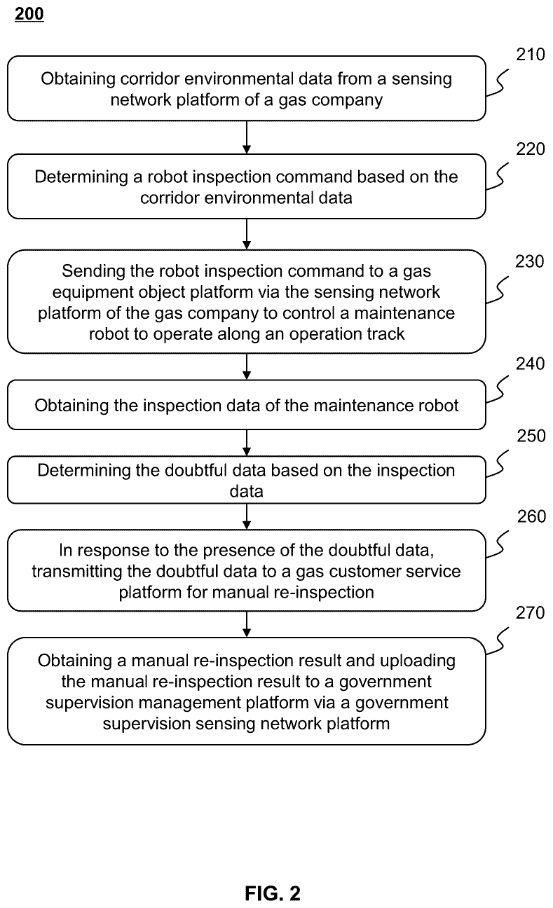

In some embodiments, the government supervision management platform 120 and the government supervision sensing network platform 130 may interact with each other for information. For example, a manual re-inspection result may be uploaded to the government supervision management platform 120 through the government supervision sensor network platform 130. For example, a pipeline corridor use hazard may be uploaded to the government supervision management platform 120 through the government supervision sensing network platform 130. More descriptions of this section may be found in FIG. 2 to FIG. 3 and their related descriptions.

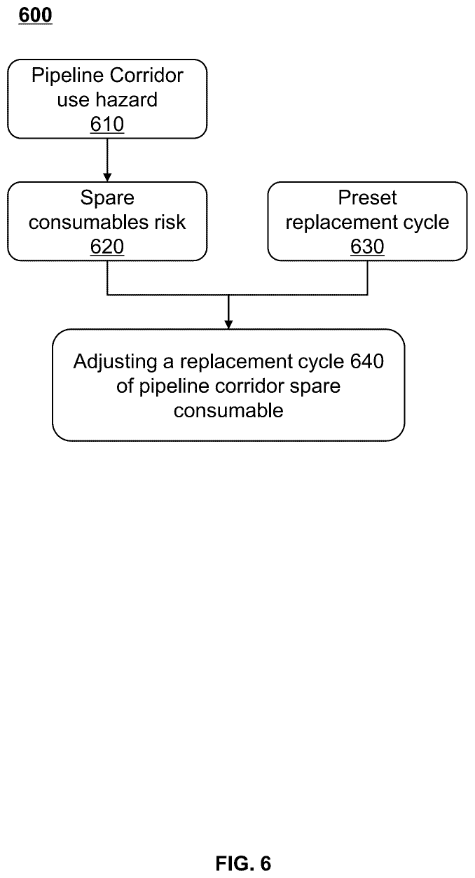

The gas customer service platform 140 may be a platform that provides information related to gas safety. In some embodiments, the gas customer service platform 140 may obtain feedback information from an anomaly monitoring device, more descriptions of this section may be found in FIG. 3 and its related descriptions. In some embodiments, the gas customer service platform 140 may obtain the manual re-inspection result, and more descriptions of this section may be found in FIG. 6 and its related descriptions.

The government supervision object platform 150 may be a platform for providing data related to gas usage, operation, safety, or the like. In some embodiments, the government supervision object platform 150 may include a management platform of the gas company 151. The management platform of the gas company 151 may be a platform that orchestrates and coordinates the connection and collaboration between the functional platforms, and aggregates all of the information of the IoT, and provides sensing management and control management functions for the entire system.

In some embodiments, the government supervision sensing network platform 130 and the government supervision object platform 150 may interact with each other for information. For example, the government supervision object platform 150 may upload inspection data to the government supervision sensing network platform 130, and more descriptions of this section may be found in FIG. 2 and its related descriptions.

In some embodiments, the management platform of the gas company 151 may obtain a pipeline corridor complexity, and more descriptions of this section may be found in FIG. 2 and its related descriptions.

In some embodiments, the management platform of the gas company 151 may interact with the gas customer service platform 140. For example, the management platform of the gas company 151 may transmit doubtful data to the gas customer service platform 140 for manual re-inspection. As another example, the management platform of the gas company 151 may upload the anomaly monitoring device to the gas customer service platform 140. More descriptions of this section may be found in FIG. 2 to FIG. 3 and their related descriptions.

The sensing network platform of the gas company 160 may be a functional platform for managing sensing communications. In some embodiments, the sensing network platform of the gas company 160 may obtain corridor environmental data. In some embodiments, the sensing network platform of the gas company 160 may send a robot inspection command to the gas equipment object platform 170. More descriptions of this section may be found in FIG. 2 and its related descriptions.

In some embodiments, the sensing network platform of the gas company 160 may upload the corridor environmental data to the management platform of the gas company 151.

The gas equipment object platform 170 may provide a functional platform for information generation and control of information execution. For example, the management platform of the gas company 151 may send the robot inspection command through the sensing network platform of the gas company 160 to the gas equipment object platform 170 to control the maintenance robot to operate along an operation track. More descriptions of this section may be found in FIG. 2 and its related descriptions.

In some embodiments, the gas equipment object platform 170 may include a pipeline corridor monitoring device, a maintenance robot, an operation track, and a processor.

In some embodiments, the pipeline corridor monitoring device distributed and deployed inside the pipeline corridor may be configured to monitor and collect the corridor environmental data; and based on the sensing network platform of the gas company 160, upload the corridor environmental data to the management platform of the gas company 151. The pipeline corridor refers to an underground space where the gas pipeline is located.

In some embodiments, the operation track may refer to a track used for the maintenance robot to perform directional movement to perform tasks such as inspection, maintenance, or the like.

In some embodiments, the maintenance robot is configured to perform an inspection along the operation track and obtain inspection data based on the robot inspection command.

In some embodiments, the IoT system 100 for managing the gas pipeline corridor robot based on the regulatory IoT may deploy associated pipeline corridor monitoring devices at different positions within the corridor for collecting the corridor environmental data.

In some embodiments, in response to the IoT system 100 for managing the gas pipeline corridor robot based on the regulatory IoT analyzing and determining the presence of the pipeline corridor use hazard based on the corridor environmental data, the maintenance robot may automatically start a robotic inspection based on the robot inspection command and obtain the inspection data. For example, the maintenance robot may conduct the inspection along a preset track, in which the track may be suspended above a sidewall of the corridor. More descriptions of this section may be found in FIG. 2 and its related descriptions.

In some embodiments of the present disclosure, introducing the maintenance robot for inspection by the IoT system 100 for managing the gas pipeline corridor robot based on the regulatory IoT may compensate for limitations of the pipeline corridor monitoring device and improve the mobility and flexibility of the corridor monitoring. Meanwhile, it may also reduce labor costs. For example, in case of an alarm, there is no need to dispatch personnel to the alarm site of the monitoring device for inspection.

In some embodiments, the management platform of the gas company 151 may obtain an inspection result of the maintenance robot from the gas equipment object platform 170 based on the sensing network platform of the gas company 160, which are then uploaded via the government supervision sensing network platform 130 to the government supervision management platform 120. The inspection result of the system for managing a gas pipeline corridor robot based on the regulatory IoT refer to data and information obtained after inspection scheduling performed by the maintenance robot. For example, the inspection result may include a number of inspections, a frequency, a position, or the like, to demonstrate the gas company's conscientious execution of the government's relevant safety supervision system.

In some embodiments, the management platform of the gas company 151 may obtain uploaded inspection data on a corridor use hazard based on a third-party platform (e.g., a water company, an electric company, etc.) as a reference, to facilitate the gas company's understanding of corridor usage and ensure the safe operation of the corridor. The inspection data of the pipeline corridor use hazard refers to data related to the inspection of the pipeline corridor use hazard conducted by the third-party platform. For example, the inspection data of the pipeline corridor use hazard may include an inspection time, a position where the pipeline corridor use hazard exists, a type of the pipeline corridor use hazard, or the like.

In some embodiments, the processor is configured to upload the corridor environmental data collected by the pipeline corridor monitoring device to the sensing network platform of the gas company 160; based on the robot inspection command: control the maintenance robot to operate along the operation track; obtain the maintenance robot's inspection data, and upload the inspection data to the sensing network platform of the gas company 160, and further upload the inspection data to the government supervision sensing network platform 150 based on the government supervision sensing network platform 150.

More descriptions of this section may be found in FIG. 2 and its related descriptions.

In some embodiments of the present disclosure, the IoT system for managing the gas pipeline corridor based on the regulatory IoT may be coordinated and operated regularly under a unified management of a smart gas management platform, and automated monitoring of the facilities and equipment inside the comprehensive pipeline corridor may be realized.

In some embodiments, the IoT system 100 for managing the gas pipeline corridor robot based on the regulatory IoT may be divided into a smart gas primary network and a smart gas secondary network. The smart gas primary network refers to a network in which the government user regulates the operation of a gas pipeline network, and the smart gas secondary network includes a network in which a gas pipeline network operates. In some embodiments, the same platform in the IoT system 100 for managing the gas pipeline corridor robot based on the regulatory IoT may assume different platform roles in the smart gas primary network and the smart gas secondary network.

In some embodiments, the smart gas primary network may at least include a smart gas primary network service platform, a smart gas primary network management platform, a smart gas primary network sensor network platform, and a smart gas primary network object platform. The smart gas primary network service platform may include a government supervision service platform 110, the smart gas primary network management platform may include a government supervision management platform 120, and the smart gas primary network sensor network platform may include a government supervision sensing network platform 130, and the smart gas primary network object platform may include a government supervision object platform 150.

In some embodiments, the smart gas secondary network may at least include a smart gas secondary network service platform, a smart gas secondary network management platform, a smart gas secondary network sensor network platform, and a smart gas secondary network object platform. The smart gas secondary network service platform may include a gas customer service platform 140, the smart gas secondary network management platform may include a management platform of the gas company 151, the smart gas secondary network sensor network platform may include a sensing network platform of the gas company 160, and the smart gas secondary network object platform may include a gas equipment object platform 170.

More descriptions of the operation of the IoT system 100 for managing the gas pipeline corridor robot based on the regulatory IoT may be found in in FIG. 2 to FIG. 6 and its related description.

It should be noted that the above description of the IoT system for managing the gas pipeline corridor robot based on the regulatory IoT is provided for descriptive convenience only, and does not confine to the present disclosure to the scope of the cited embodiments.

FIG. 2 is an exemplary flowchart illustrating a process for managing a gas pipeline corridor robot based on regulatory Internet of Things according to some embodiments of the present disclosure. As shown in FIG. 2, a process 200 includes the following operations. In some embodiments, the process 200 may be performed by the management platform of the gas company.

In 210, corridor environmental data may be obtained from a sensing network platform of the gas company.

The corridor environmental data refers to relevant environmental data within the corridor. In some embodiments, the corridor environmental data may include a temperature, a humidity, a gas concentration, an airborne particulate concentration, and a light intensity inside the pipeline corridor.

In some embodiments, the gas concentration may include a concentration of gas and/or other hazardous gases. The hazardous gases refer to gases that may pose a safety risk to the equipment or personnel within the pipeline corridor. For example, the hazardous gases may include sulfur dioxide and carbon dioxide, among others.

The pipeline corridor refers to an underground pipeline space where the gas line is located. In some embodiments, the pipeline corridor may consist of one or more pipeline corridor regions.

The pipeline corridor region is a partial region within the pipeline corridor system. For example, the pipeline corridor may be divided into multiple regions of preset shapes according to these shapes, with each preset shape corresponding to a pipeline corridor region. The above division is merely an example, and in practice, the pipeline corridor may be divided in any feasible manner to obtain a corresponding pipeline corridor region.

In some embodiments, the corridor environmental data is monitored and collected by pipeline corridor monitoring devices of the gas equipment object platform. For example, the pipeline corridor monitoring devices are distributed and deployed inside the pipeline corridor to monitor and collect the corridor environmental data.

In some embodiments, the corridor environmental data is uploaded by the pipeline corridor monitoring devices to the management platform of the gas company via the sensing network platform of the gas company. In some embodiments, the corridor environmental data collected by the pipeline corridor monitoring devices is uploaded by a processor of the gas equipment object platform to the sensing network platform of the gas company, and the management platform of the gas company obtains the corridor environmental data from the sensing network platform of the gas company.

In 220, a robot inspection command may be determined based on the corridor environmental data.

The robot inspection command is a command that instructs the maintenance robot whether or not to perform an inspection operation. In some embodiments, the robot inspection command includes a command to perform the inspection and a command not to perform the inspection. In some embodiments, the command to perform the inspection may include one or more operation indications for performing inspection, and maintenance robots pointed to by each operation indication. In some embodiments, the instruction to perform the inspection may also include an inspection item corresponding to the maintenance robot.

It can be understandable that one or more maintenance robots may be set up inside the corridor, and each maintenance robot may be responsible for inspecting and maintaining one or more pipeline corridor regions, and the functions of different maintenance robots may be the same or different.

In some embodiments, the management platform of the gas company may monitor whether an abnormal value exists in the corridor environmental data, and determine a robot inspection command based on a monitoring result. The abnormal value refers to corridor environmental data that falls outside a preset environmental range. The preset environmental range refers to a numerical range of environmental data corresponding to a preset normal corridor environment. For example, the preset environmental range may include a preset temperature range, a preset humidity range, a preset gas concentration range, or the like.

For example, the management platform of the gas company monitors that a current temperature of a pipeline corridor region is outside a preset temperature range (e.g., −20° C. to 50° C.). In response to a monitoring result indicating the presence of an abnormal temperature value in the corridor environmental data of the above-mentioned pipeline corridor region, the management platform of the gas company may determine a robot inspection command for the maintenance robot that may obtain temperature detection data. The robot inspection command is associated with a temperature anomaly in the above-mentioned pipeline corridor region.

The inspection item is an item that needs to be performed during an inspection process. In some embodiments, the inspection item includes an image acquisition, a sound acquisition, and a sensing data detection. The sensing data detection may include temperature detection, humidity detection, gas concentration detection, airborne particulate matter concentration detection, and detection of other hazardous gas concentrations. For example, the inspection item related to the temperature anomaly may include an inspection item for a low-temperature anomaly and an inspection program for a high-temperature anomaly. For example, the inspection item for the high-temperature anomaly may include temperature detection, air particulate matter concentration detection, detection of other hazardous gas concentrations, and image acquisition, or the like. The inspection item for the low-temperature anomaly may include temperature detection and gas concentration detection.

The management platform of the gas company may determine the inspection item in a variety of ways. In some embodiments, the management platform of the gas company may determine the inspection item by querying a preset table based on a monitoring result indicating the presence of an abnormal value in the corridor environmental data. A mapping relationship between the monitoring result and the inspection item is stored in the preset table. For example, if the monitoring result indicates an abnormally high temperature value in the corridor environmental data, the management platform of the gas company may determine through querying the preset table that the inspection item matching this monitoring result is the inspection item for the high-temperature anomaly.

In 230, the robot inspection command may be sent to a gas equipment object platform via the sensing network platform of the gas company to control a maintenance robot to operate along an operation track.

In some embodiments, the management platform of the gas company sends the robot inspection command to a processor of the gas equipment object platform via the sensing network platform of the gas company. The processor may control the maintenance robot directed by the robot inspection command to operate along the operation track based on the received robot inspection command. The maintenance robot pointed to by the command may perform an inspection along the operation track and obtain inspection data based on the robotic inspection command.

In 240, inspection data of the maintenance robot may be obtained.

The inspection data refers to external pipeline data obtained by the maintenance robot during the execution of the robotic inspection command, such as, environmental data outside the pipeline, audio-visual image data inside the pipeline corridor, or the like.

In some embodiments, the inspection data includes one or more pieces of inspection sub-data, a pipeline corridor region corresponding to each of the one or more pieces of inspection sub-data, and at least one piece of environmental monitoring data.

Exemplarily, the inspection sub-data is temporally continuous data that may include at least one of image data and sound data. It can be understandable that one piece of inspection sub-data may correspond to one or more pipeline corridor regions, and a pipeline corridor region may also correspond to one or more pieces of inspection sub-data.

The environmental monitoring data refers to data related to environmental parameters within the pipeline corridor.

Exemplarily, the environmental monitoring data includes at least one of temperature data, humidity data, gas concentration data, airborne particulate matter concentration, and light intensity.

The inspection sub-data may be obtained by dividing the inspection data in various ways. In some embodiments, for inspection data obtained by the same maintenance robot when executing a specified robotic inspection command, multiple pieces of inspection sub-data contained in the inspection data may be divided based on different pipeline corridor spaces and/or different inspection time periods. For example, among the multiple pieces of inspection sub-data of the inspection data, each piece of inspection sub-data corresponds to a pipeline corridor space, or each piece of inspection sub-data corresponds to an inspection time period.

In some embodiments, the management platform of the gas company may obtain the inspection data from the sensor network platform of the gas company. In some embodiments, the maintenance robot may directly upload the inspection data to the sensor network platform of the gas company. In other embodiments, the processor of the gas equipment object platform obtains the inspection data from the maintenance robot and uploads it to the sensor network platform of the gas company. The processor of the gas equipment object platform further uploads the inspection data to the government supervision sensor network platform through the government supervision object platform.

The robotic inspection instruction sent by the management platform of the gas company may be received by the processor via the sensor network platform of the gas company. The processor controls the maintenance robot for inspection, inspection data collection, and related information exchange, thereby automating the inspection-related processes.

In 250, doubtful data may be determined based on the inspection data.

The doubtful data refers to data whose reliability is questionable. This questionable reliability of data indicates the accuracy of potential safety risk in the pipeline corridor. The safety risks may include a fire risk, a corrosion risk, and an equipment damage risk. Abnormal data reflecting fire risk may include abnormal temperature data, abnormal air particulate matter concentration data, abnormal image and sound data that may indicate fire, etc. The doubtful data reflecting corrosion risk may include abnormal temperature data, abnormal humidity data, and abnormal risk gas concentration data. Abnormal data reflecting the risk of equipment damage may include abnormal gas concentration data.

In some embodiments, the management platform of the gas company may determine whether environmental monitoring data in the inspection data of the corresponding pipeline corridor region is consistent with the results indicated by the corridor environment data of the corresponding pipeline corridor region. If one of the two indicates that there is a safety risk in the corresponding pipeline corridor region (such as a safety risk higher than a preset threshold), while the other indicates that there is no safety risk in the corresponding pipeline corridor region (such as a safety risk not higher than the preset threshold), then the management platform of the gas company may determine the inspection data and corridor environment data of the corresponding pipeline corridor region as the doubtful data.

In some embodiments, the doubtful data is also related to a pipeline corridor complexity. The pipeline corridor complexity refers to data that indicates the complexity of the structure, operation, and use of the pipeline corridor. It can be understandable that the higher the pipeline corridor complexity is, the higher the possibility of obtaining abnormal corridor environment data due to monitoring device errors, and thus the lower the reliability of inspection data or corridor environment data, that is, the higher the probability that inspection data or corridor environment data is the doubtful data.

In some embodiments, the pipeline corridor complexity is related to information about a type and a number of pipelines in and around other compartments of the pipeline corridor. The management platform of the gas company may determine the pipeline corridor based on the pipeline type information and pipeline quantity information in and around other compartments of the pipeline corridor complexity. For example, the more pipeline types and quantities in and around other compartments of the pipeline corridor are, the higher the pipeline corridor complexity is.

In some embodiments, the pipeline corridor complexity is also related to an average distance between pipelines. The average pipeline distance refers to an average distance between each pipeline in the pipeline corridor. For example, the smaller the average pipeline distance is, the higher the pipeline corridor complexity is.

In some embodiments, the management platform of the gas company may determine the doubtful data based on the inspection data, the pipeline corridor complexity, and by querying a preset data table. The preset data table includes historical pipeline corridor regions, inspection data for historical pipeline corridor regions, corridor environment data, pipeline corridor complexity, and corresponding historical doubtful data for the historical pipeline corridor regions. The management platform of the gas company may search the preset data table based on a current various pipeline corridor region and its corresponding inspection data, corridor environment data, and pipeline corridor complexity. It determines the historical doubtful data corresponding to the data that is the same or closest to the various pipeline corridor regions and their corresponding inspection data, corridor environment data, and pipeline corridor complexity. Based on this historical doubtful data, the current doubtful data is determined.

By considering the impact of pipeline corridor complexity on the reliability of inspection data when determining the doubtful data, the management platform of the gas company may reduce the problem of machine misjudgment and control the frequency and number of requests for manual intervention within a suitable range.

In some embodiments, the doubtful data may also be determined based on other methods. More descriptions of this section may be found in FIG. 3 and its related descriptions.

In 260, in response to the presence of the doubtful data, the doubtful data may be transmitted to a gas customer service platform for manual re-inspection.

The manual re-inspection refers to the operation of manually assessing whether there are safety risks in the pipeline corridor region corresponding to the doubtful data. A manual re-inspection result may indicate the absence or presence of safety risks in the corresponding pipeline corridor region. For example, a manager may obtain more assessment data (e.g., video data of the pipeline corridor, manual inspection data, etc.), and determine the manual re-inspection result of the corresponding pipeline corridor region based on this assessment data.

In some embodiments, in response to the presence of doubtful data, the management platform of the gas company may transmit the doubtful data to the gas user service platform, enabling the gas user service platform to arrange manual re-inspection tasks. The gas user service platform may obtain the manual re-inspection result uploaded by the manager.

In 270, a manual re-inspection result may be obtained and the manual re-inspection result may be uploaded to a government supervision management platform via a government supervision sensing network platform.

In some embodiments, the management platform of the gas company may obtain the manual re-inspection result from the gas user service platform and then upload the result to the government supervision management platform via the government supervision sensor network platform. This allows the government supervision management platform to store the manual re-inspection result for subsequent supervision of underground pipeline corridors. Additionally, it enables the government supervision management platform to provide the manual re-inspection result to other institutions related to the maintenance and operation of the underground pipeline corridor, serving as reference information for these institutions to formulate work plans.

In some embodiments, in response to the absence of doubtful data, the management platform of the gas company may determine potential risks in the use of the pipeline corridor based on the inspection data. These risks are then uploaded to the government supervision management platform via the government supervision sensor network platform. Based on these risks, a replacement cycle of a pipeline corridor spare consumable may be adjusted.

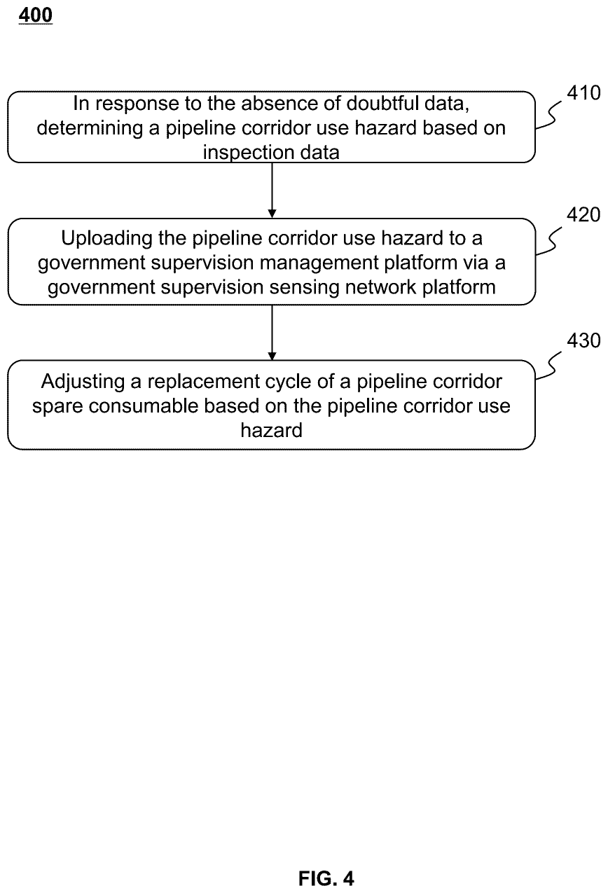

More descriptions of the determining potential risks in the pipeline corridor usage and adjusting the replacement cycle may be found in FIGS. 4 and 6 and their related descriptions.

The method for managing the gas pipeline corridor robot based on the regulatory IoT, provided in some embodiments of the present disclosure, reduces the frequency and number of manual interventions throughout the entire process by determining doubtful data based on inspection results. This minimizes the impact of inefficient manual assessments and varying levels of rigor in assessments on pipeline corridor safety risk identification. The method for managing the gas pipeline corridor robot based on the regulatory IoT provided in the embodiments of the present disclosure enables intelligent and automated dynamic monitoring of the internal facilities and equipment of the integrated pipeline corridor.

FIG. 3 is an exemplary flowchart illustrating a process for determining doubtful data according to some embodiments of the present disclosure. As shown in FIG. 3, a process 300 includes the following operations. In some embodiments, the process 300 may be executed by the management platform of the gas company.

In 310, an anomaly monitoring device may be determined based on the environmental monitoring data and the maintenance record.

The maintenance record refers to a record of maintenance and servicing performed on equipment, a system, or a facility within the pipeline corridor. In some embodiments, the maintenance record may refer to a record of maintenance and servicing performed on a pipeline corridor monitoring device. For example, the maintenance record may include detailed records of inspections, repairs, replacement of parts, and other operations performed on the pipeline corridor monitoring device.

In some embodiments, the management platform of the gas company may obtain the maintenance record of the pipeline corridor monitoring device through various means. For example, the maintenance record of the pipeline corridor monitoring device may be obtained based on the government safety regulatory management platform.

The anomaly monitoring device refers to the pipeline corridor monitoring device that may have malfunctions, damage, or inaccuracies within the pipeline corridor.

In some embodiments, the management platform of the gas company may determine the anomaly monitoring device based on the environmental monitoring data and the maintenance record. For example, when a time interval between a last maintenance record of the pipeline corridor monitoring device and a current time is greater than a preset time threshold, and the environmental monitoring data is not within a preset environmental range, the monitoring device may be determined as an anomaly monitoring device.

The preset time threshold refers to a predefined threshold for the time interval, and the preset environmental range refers to a range of conditions used to determine whether the environmental monitoring data is within a normal range. The preset time threshold and the preset environmental range may be set by technicians based on experience or by system defaults.

In 320, the anomaly monitoring device may be uploaded to the gas customer service platform.

More descriptions of the gas user service platform may be found in FIG. 1 and its related descriptions.

In 330, in response to obtaining feedback information of the anomaly monitoring device from the gas customer service platform, the doubtful data may be determined based on the one or more pieces of inspection sub-data, the pipeline corridor region corresponding to each of the one or more pieces of inspection sub-data, and the pipeline corridor complexity, and the feedback information.

The feedback information refers to information used to provide feedback related to the anomaly monitoring device. For example, the feedback information may include confirmation that the anomaly monitoring device is indeed experiencing abnormalities. The management platform of the gas company may obtain user feedback on the anomaly monitoring device from the gas user service platform.

In some embodiments, the management platform of the gas company may determine the doubtful data based on various manners. For example, the management platform of the gas company may identify the inspection data corresponding to the pipeline corridor region where the anomaly monitoring device is located as the doubtful data.

In some embodiments, the doubtful data is also related to an environmental dataset within the pipeline corridor, which includes environmental data from one or more target monitoring nodes within the corridor.

In some embodiments, the determining the doubtful data based on one or more pieces of inspection sub-data, the pipeline corridor region corresponding to each of the one or more pieces of inspection sub-data, and the pipeline corridor complexity, and the feedback information includes: determining the doubtful data by a data determination model, wherein the data determination model is a machine learning model, based on one or more pieces of inspection sub-data, the pipeline corridor region corresponding to each of the one or more pieces of inspection sub-data, and the pipeline corridor complexity, and the feedback information.

The environmental dataset within the corridor refers to a dataset comprised of environmental data from target monitoring nodes within the pipeline corridor. The target monitoring nodes include pre-selected monitoring nodes and other monitoring nodes whose distance from the pre-selected nodes is less than or equal to a distance threshold.

The monitoring node refers to a position node within the pipeline corridor region where the pipeline corridor monitoring device is set up. The pre-selected monitoring nodes may be positions corresponding to the pipeline corridor monitoring device in important pipeline corridor regions, such as those housing main pipelines or regions with the highest incidence of accidents. The distance threshold may be set by technicians based on experience or by system defaults.

In some embodiments, the management platform of the gas company may determine the doubtful data based on a data determination model, which may be a machine learning model such as a convolutional neural network model, recurrent neural network model, or any combination thereof.

In some embodiments, an input of the data determination model may include the environmental dataset within the corridor, one or more pieces of inspection sub-data, the pipeline corridor region corresponding to each of the one or more pieces of inspection sub-data, and the pipeline corridor complexity, and the feedback information, while an output may be the doubtful data. More descriptions of the environmental dataset within the corridor, the inspection sub-data, the corresponding pipeline corridor regions, the pipeline corridor complexity, and the doubtful data may be found in FIG. 2 and their related descriptions.

In some embodiments, the data determination model may be trained using a large number of first training samples with first labels. The multiple first training samples with first labels may be input into an initial data determination model, and a loss function may be constructed based on the first labels and the results of the initial data determination model. Parameters of the initial data determination model may then be iteratively updated based on the loss function. The model training is complete when the loss function of the initial data determination model meets a preset condition, resulting in a trained data determination model. The preset condition may include convergence of the loss function, reaching a threshold number of iterations, etc. In some embodiments, the first training samples may include sample environmental datasets within the corridor, one or more pieces of sample inspection sub-data, sample pipeline corridor regions corresponding to each of the one or more pieces of sample inspection sub-data, sample pipeline corridor complexity, and sample feedback information from historical data. The first labels may be the subsequently determined doubtful data corresponding to the first training samples. In some embodiments, the doubtful data may include inspection data that does not match initial inspection data after actual investigation, inspection data that caused the failure, and inspection data related to the failure. The doubtful data may be determined based on manual inspection or review and manually labeled to obtain the first labels.

In some embodiments, the doubtful data is also related to a pipeline corridor use hazard. For example, the input of the data determination model may also include a pipeline corridor use hazard. More descriptions of the pipeline corridor use hazard may be found in FIG. 4 and its related descriptions.

When the input of the data determination model includes the pipeline corridor use hazard, the first training samples may also include sample pipeline corridor use hazards.

In some embodiments of the present disclosure, setting the pipeline corridor use hazard as an input to the data determination model allows the model to evaluate the doubtful data in the presence of the pipeline corridor use hazard, thereby enabling the model to accurately identify the doubtful data and improve model accuracy.

In some embodiments of the present disclosure, the management platform of the gas company uses a machine learning model to determine the doubtful data, which helps identify potential issues and abnormalities. Additionally, determining the doubtful data using the data determination model allows for more accurate predictions of doubtful data, facilitating the identification of doubtful data that more closely aligns with actual conditions. Furthermore, by prioritizing pre-selected monitoring nodes as a starting point and incorporating corridor data from nearby monitoring nodes into the calculation, high-accuracy results may be obtained using only a few nodes, thereby reducing computational complexity and improving efficiency.

It should be noted that the above description of the process 300 is provided solely for illustrative and explanatory purposes and does not limit the scope of the present disclosure. Those skilled in the art can make various modifications and changes to the process 300 under the guidance of the present disclosure. However, these modifications and changes remain within the scope of the present disclosure. In some embodiments, the method for managing a gas pipeline corridor robot based on the regulatory IoT also includes adjusting a replacement cycle of a pipeline corridor spare consumable. FIG. 4 is an exemplary schematic diagram illustrating a process for adjusting a replacement cycle according to some embodiments of the present disclosure. As shown in FIG. 4, a process 400 includes the following operations. In some embodiments, the process 400 may be executed by the management platform of the gas company.

In 410, in response to the absence of suspicious data, the pipeline corridor use hazard may be determined based on the inspection data.

The pipeline corridor use hazard refers to potential problems, defects, or non-compliance with regulatory requirements that exist in the pipeline within the corridor or in the internal environment of the corridor. In some embodiments, the pipeline corridor use hazard may include at least one of continuous water seepage in pipeline, peeling of anticorrosive coatings, and aging of pipeline.

In some embodiments, the management platform of the gas company may determine the pipeline corridor use hazard in multiple ways. In some embodiments, it may be based on the inspection data. For example, the inspection data may include image data of the pipeline, allowing the platform to determine the presence of cracks and thus potential hazards. Alternatively, it may be based on whether the pressure difference inside and outside the corridor exceeds a pressure threshold. This threshold may be set by technicians based on experience or by system defaults.

In some embodiments, the inspection data also includes image data and sound data.

In some embodiments, the determining the pipeline corridor use hazard based on the inspection data includes determining the pipeline corridor use hazard based on the image data and the sound data.

The image data refers to relevant images captured during inspections, such as photos, videos, or infrared images of pipelines or the corridor's internal environment.

The sound data includes sounds related to the corridor, such as water leaks, pressure anomalies, or equipment malfunctions.

In some embodiments, the management platform of the gas company determines the pipeline corridor use hazard by querying a preset relationship table based on the image and sound data. This relationship table correlates the image and sound data with the pipeline corridor use hazard and may be determined based on historical data. By referencing this table, the management platform of the gas company may identify the pipeline corridor use hazard corresponding to similar image and sound data.

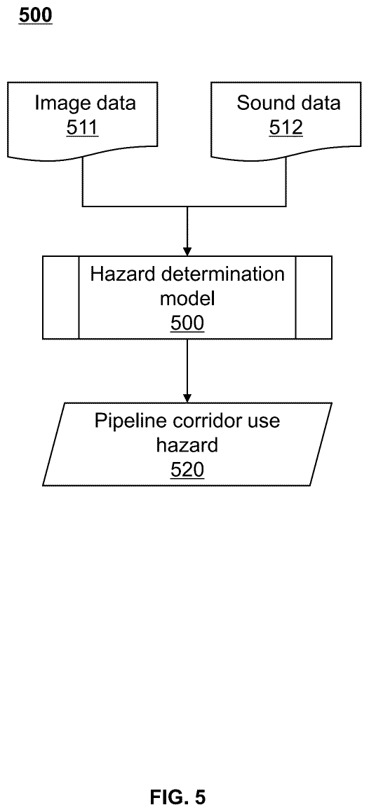

More descriptions of determining the pipeline corridor use hazard may be found in FIG. 5 and its related descriptions.

In some embodiments of the present disclosure, a comprehensive analysis of image and sound data provides a more comprehensive determination of the pipeline corridor use hazard, ensuring the safe operation and use of the corridor.

In 420, the pipeline corridor use hazard may be uploaded to the government supervision management platform via the government supervision sensing network platform.

More descriptions of the government supervision management platform and the government supervision sensing network platform may be found in FIG. 1 and their related descriptions.

In 430, a replacement cycle of a pipeline corridor spare consumable may be adjusted based on the pipeline corridor use hazard.

The pipeline corridor spare consumable refers to consumable materials used for replacement, repair, or backup during corridor operation. These may include emergency supplies, maintenance materials, and rescue materials.

The replacement cycle of the pipeline corridor spare consumable refers to a time interval or frequency for replacing the pipeline corridor spare consumable during corridor operation and maintenance.

In some embodiments, the management platform of the gas company may adjust the replacement cycle in multiple ways. For example, if the pipeline corridor use hazard exceeds a hazard preset threshold, management platform of the gas company may shorten the replacement cycle. Conversely, if the pipeline corridor use hazard is below the hazard preset threshold, the replacement cycle may be extended.

This hazard preset threshold is used to determine whether adjustments to the replacement cycle are necessary and may be set by technicians based on experience or by system defaults.

More descriptions of adjusting the replacement cycle may be found in FIG. 6 and its related descriptions.

It should be noted that the above description of the process 400 is for illustrative purposes only and does not limit the scope of the present disclosure. Those skilled in the art can make various modifications and changes to the process 400 under the guidance of the present disclosure. However, these modifications and changes remain within the scope of the present disclosure.

FIG. 5 is an exemplary diagram illustrating a hazard determination model according to some embodiments of the present disclosure.

In some embodiments, the management platform of the gas company may determine a pipeline corridor use hazard 520 based on image data 511 and sound data 512 through a hazard determination model 500.

In some embodiments, the hazard determination model 500 is a machine learning model. Exemplary machine learning model that may serve as a hazard determination model include, but is not limited to, a logistic regression model, a neural network model (e.g., a convolutional neural network, CNN), or the like. In some embodiments, the hazard determination model 500 is a CNN.

In some embodiments, an input of the hazard determination model 500 includes image data 511 and sound data 512. The image data 511 is derived from inspection data, and the sound data 512 is also from the inspection data. In some embodiments, an output of the hazard determination model 500 is the pipeline corridor use hazard 520.

More descriptions of the pipeline corridor use hazard may be found in FIG. 4 and its related descriptions.

The hazard determination model may be trained based on first training samples with first labels. Multiple first training samples with first labels may be input into an initial hazard determination model. A loss function is constructed based on the first labels and the results of the initial hazard determination model. The parameters of the initial hazard determination model are iteratively updated based on the loss function. When the loss function of the initial hazard determination model satisfies a preset condition, model training is completed, resulting in a trained hazard determination model. The preset condition may be convergence of the loss function, the number of iterations reaching a threshold, or the like.

In some embodiments, the first training samples may include historical image data and historical sound data from historical inspection data of various sample pipeline regions. In some embodiments, the first labels may represent hazards in the use of pipeline in various sample pipeline regions at historical time points. For example, the first labels may be determined through manual annotation based on whether actual hazards or accidents occurred in the sample pipeline regions during subsequent inspections. If a hazard/accident occurs, the first label is marked as 1; if not, it is marked as 0.

In some embodiments, the model training of the hazard determination model 500 includes at least a first stage of training. The first stage of training involves training the hazard determination model based on a first training set, which includes a preset proportion of first category data, second category data, and third category data.

The preset proportion refers to the proportion of first category data, second category data, and third category data in the first training set, which is determined based on experience. For example, the preset proportion of first category data, second category data, and third category data in the first training set may be 1:2:4.

In some embodiments, the first category data includes image and sound data from sample pipeline regions where hazards have occurred. “Hazards have occurred” refers to situations where the sample pipeline regions have been verified to have experienced actual pipeline corridor use hazards or accidents during subsequent inspections. In some embodiments, the first category data may be collected from a database. For example, historical inspection data may be collected from the database of the gas user service platform, and historical image data and historical sound data from sample pipeline regions where hazards have occurred may be used as the first category data.

In some embodiments, the second category data is modified image data and sound data. In some embodiments, the second category data is created by applying noise processing to the image data and/or transformation processing to the sound data from at least one group of sample pipeline regions where hazards have occurred. The image data and sound data from these sample pipeline regions may be collected from a database, similar to the acquisition of the first category data.

In some embodiments, applying noise processing to the image data from at least one group where hazards have occurred involves applying one or more types of noise to each set of image data. The noise may include salt and pepper noise, Gaussian noise, Poisson noise, or the like. It can be understood that noise processing involves randomly adding one or more types of noise to the image data to achieve the effect of fault data augmentation.

In some embodiments, applying transformation processing to the sound data from at least one group where hazards have occurred involves randomly adding at least one set of transformations to each set of sound data. The transformations may include audio splitting, audio stretching, pitch shifting, pitch offset, and adding background noise. It can be understood that transformation processing involves randomly applying one or more sets of transformations to the sound data to achieve the purpose of fault data augmentation.

In some embodiments, the third category data includes image data and sound data from sample pipeline regions where no hazards have occurred. “No hazards have occurred” refers to situations where the sample pipeline regions have been verified to have not experienced any actual hazards or accidents during subsequent inspections. In some embodiments, the third category data may be collected from a database. For example, historical inspection data may be collected from the database of the gas user service platform, and historical image data and historical sound data from sample pipeline regions where no hazards have occurred may be used as the third category data.

Expanding the types and quantity of training sample data may enhance the generalization ability of the hazard determination model and reduce the risk of overfitting. Additionally, it allows for the full utilization of limited sample data.

In some embodiments, the proportion of second category data in the first training set may be determined based on the pipeline corridor complexity. For example, the higher the pipeline corridor complexity is, the higher the proportion of second category data in the first training set is. The proportion of second category data in the first training set may be determined by querying a preset table. The preset table stores a mapping relationship between the proportion of second category data and the pipeline corridor complexity.

The higher the pipeline corridor complexity is, the more prone they are to failures or hazards caused by uncertain factors during operation. Determining the proportion of second category data in the first training set based on the pipeline corridor complexity allows the first training set to obtain as many generalized fault samples as possible, improving the accuracy of the model's judgments. Additionally, optimizing the proportion of various types of training sample data in the first training set may enhance the quality of the first training set, further improving the accuracy of the hazard determination model's judgments.

It can be understood that in some embodiments, a trained hazard determination model may be obtained after completing the first stage of training. In other embodiments, the hazard determination model that has completed the first stage of training may continue to be trained and optimized.

In some embodiments, the model training of the hazard determination model 500 further includes a second stage of training. The second stage of training involves training the hazard determination model based on a second training set. The second training set includes fourth category data and fifth category data.

The fourth category data and fifth category data may originate from the input data used in the actual application of the hazard determination model that has completed the first stage of training.

In some embodiments, the fourth category data includes image data and sound data from pipeline regions where no hazards have occurred. When these data are used as input for the hazard determination model that has completed the first stage of training, the model outputs a hazard value greater than a preset value. For example, the hazard determination model that has completed the first stage of training outputs a hazard value of 1 or another value greater than 0.6. This means that the fourth category data represents pipeline regions that the model has mistakenly identified as having hazards.

In some embodiments, the fifth category data includes image data and sound data from pipeline regions where hazards have occurred. When these data are used as input for the hazard determination model that has completed the first stage of training, the model outputs a hazard value less than a preset value. For example, the hazard determination model that has completed the first stage of training outputs a hazard value of 0 or another value less than 0.6. This means that the fifth category data represents pipeline regions where the model has failed to identify the presence of hazards.

The second stage of training for the hazard determination model focuses on strengthening the model's weaknesses in identifying pipeline corridor use hazard. This may further improve the accuracy of the model's judgments. The second stage of training is based on data from actual assessments of pipeline corridor use hazards where the model has made misjudgments. This type of intensive training may optimize model parameters and reduce the model's subsequent misjudgment rate.

It can be understood that in some embodiments, a fully trained hazard determination model may be obtained after completing the second stage of training. In other embodiments, the hazard determination model that has completed the second stage of training may continue to be trained and optimized.

The identification of pipeline corridor use hazards may be judged through the hazard determination model, which may quickly identify key factors from complex data. This may not only automate, speed up, and dynamically determine the pipeline corridor use hazards, but also effectively ensure the accuracy of judging pipeline corridor use hazards and reduce errors caused by manual intervention.

FIG. 6 is an exemplary flowchart illustrating a process for adjusting a replacement cycle according to some embodiments of the present disclosure.

In some embodiments, the management platform of the gas company may determine a spare consumable risk 620 based on a pipeline corridor use hazard 610; and adjust a replacement cycle 640 of pipeline corridor spare consumable based on a preset replacement cycle 630 of the pipeline corridor spare consumable and the spare consumable risk 620.

More descriptions of determining the pipeline corridor use hazard may be found in FIGS. 4 and 5, and their related descriptions.

The pipeline corridor spare consumable refers to consumable materials used for backup preparation during the operation of the pipeline corridor. In some embodiments, the pipeline corridor spare consumable may include emergency supplies, materials required for facility and equipment maintenance, and materials needed for emergency rescue.

The spare consumable risk refers to a risk of spare consumable for the pipeline corridor being damaged. For example, when a certain pipeline corridor region is at risk of fire, excessive temperatures may cause temperature-sensitive spare consumable in the pipeline corridor to be damaged.

In some embodiments, the management platform of the gas company may determine the spare consumable risk 620 based on the pipeline corridor use hazard 610 by querying a preset table. The preset table stores a mapping relationship between the pipeline corridor use hazard 610 and the spare consumable risk 620. For example, the higher the pipeline corridor use hazard is, the higher the spare consumable risk is. Assuming the pipeline corridor use hazards are 0, 1, 2, and 3, respectively, then the spare consumable risks are 0, 1, 2, and 3, respectively.

In some embodiments, the spare consumable risk 620 is also related to the doubtful data. In response to the absence of the doubtful data in the pipeline corridor region where the spare consumable is located, the management platform of the gas company may determine the spare consumable risk 620 based on the pipeline corridor use hazard 610.

If there is no doubtful data in the pipeline corridor region where the spare consumable is located, the reliability of inspection data and corridor environment data reflecting safety risks in that region is high. Thus, the accuracy of assessing potential hazards in that pipeline corridor region based on the pipeline corridor use hazard is high. Conversely, if there is doubtful data in the pipeline corridor region where the spare consumable is located, the accuracy of assessing potential hazards in that region based on the pipeline corridor use hazard decreases.

For example, if there is no doubtful data in the pipeline corridor region where a certain spare consumable is located, and the pipeline corridor use hazard in that region are 0, then the spare consumable risk is 0. If the pipeline corridor use hazard in that region is 1, then the spare consumable risk may be expressed as: spare consumable risk=k1*pipeline corridor use hazard=k1. k1 is an empirical coefficient greater than 1.

Considering the absence of doubtful data in the pipeline corridor region where the spare consumable is located when determining spare consumable risk may reduce the impact of low inspection data reliability on spare consumable risk determination, making the adjustment of replacement cycles more effective and accurate.

In some embodiments, in response to the presence of doubtful data in the pipeline corridor region where the spare consumable is located, the management platform of the gas company may obtain a manual re-inspection result from the gas user service platform; and determine the spare consumable risk 620 based on the manual re-inspection result and the pipeline corridor use hazard 610.

If the manual re-inspection result shows that a certain pipeline corridor region poses a safety risk, it may be determined that the assessment of potential hazards in that region based on the pipeline corridor use hazard is lower than the actual value. Thus, the influence of the pipeline corridor use hazard on spare consumable risk determination may be appropriately increased. For example, if the manual re-inspection result indicates a safety risk in a certain pipeline corridor region, and the pipeline corridor use hazard in that region is 1, then the spare consumable risk may be expressed as: spare consumable risk=k2*pipeline corridor use hazard=k2. k2 is an empirical coefficient greater than k1, where k1 is the empirical coefficient for determining spare consumable risk when there is no doubtful data in the pipeline corridor region.

Considering the manual re-inspection result when determining spare consumable risk allows for timely correction of the impact of underestimating the pipeline corridor use hazard on spare consumable risk determination, making the adjustment of replacement cycles more effective and accurate.

The replacement cycle refers to a time interval from when spare consumable for the pipeline corridor is put into use until they need to be replaced. For example, different types of spare consumables for the pipeline corridor may have different replacement cycles. The spare consumables that are insensitive to environmental factors such as temperature and humidity have longer replacement cycles than those sensitive to these factors.

In some embodiments, the management platform of the gas company may directly adjust the replacement cycle 640 of the pipeline corridor spare consumable by querying a preset table based on the preset replacement cycle 630 of the pipeline corridor spare consumable and the spare consumable risk 620. The preset table stores a mapping relationship between the preset replacement cycle 630, the spare consumable risk 620, and the adjusted replacement cycle.

In some embodiments, the management platform of the gas company may determine a first adjustment amount for the replacement cycle based on the spare consumable risk 620; determine a second adjustment amount for the replacement cycle based on the preset replacement cycle 630; and adjust the replacement cycle 640 of the pipeline corridor spare consumable based on the first and second adjustment amounts.

The first adjustment amount refers to an adjustment amount for the replacement cycle determined based on the spare consumable risk. The first adjustment amount may be determined by querying a first preset table based on the spare consumable risk. The first preset table stores a mapping relationship between the spare consumable risk and the first adjustment amount. For example, the smaller the spare consumable risk is, the larger the replacement cycle adjustment amount is.

The second adjustment amount refers to an adjustment amount for the replacement cycle determined based on the preset replacement cycle.

The preset replacement cycle may be determined by querying a third preset table based on the type of spare consumable set in the corresponding pipeline corridor region. The third preset table stores a mapping relationship between the type of the pipeline corridor spare consumable and the preset replacement cycle. The second adjustment amount may be positively correlated with the preset replacement cycle. For example, the second adjustment amount may be the product of the preset replacement cycle and a preset coefficient, where the preset coefficient may be preset based on historical experience.

In some embodiments, the management platform of the gas company may determine a final adjustment amount for the replacement cycle based on the first and second adjustment amounts, and adjust the replacement cycle 640 of the pipeline corridor spare consumable based on the final adjustment amount. By way of example only, the final adjustment amount may be a weighted sum of the first and second adjustment amounts. The management platform of the gas company may add the final adjustment amount to an original replacement cycle and use a final value as the adjusted replacement cycle. The weights of the first and second adjustment amounts may be preset.

In some embodiments, the management platform of the gas company may also adjust the replacement cycle 640 of the pipeline corridor spare consumable based on other methods. For example, the adjustment of the replacement cycle may be simultaneously determined based on the preset replacement cycle and the first adjustment amount. The adjusted replacement cycle may be expressed as: adjusted replacement cycle=w1*preset replacement cycle+w2*first adjustment amount. w1 and w2 are preset empirical coefficients.

Considering the spare consumable risk when adjusting the replacement cycle of the pipeline corridor spare consumable allows the adjusted replacement cycle to more effectively match the true usage period of the pipeline corridor spare consumable, reducing the impact of damage, corrosion, aging, and other factors on the use of the pipeline corridor spare consumable. Considering the spare consumable risk when adjusting the replacement cycle of the pipeline corridor spare consumable may effectively avoid safety accidents related to the pipeline corridor spare consumable while reducing pipeline corridor operating costs.

The basic concepts have been described above, apparently, in detail, as will be described above, and does not constitute limitations of the disclosure. Although there is no clear explanation here, those skilled in the art may make various modifications, improvements, and modifications of present disclosure. This type of modification, improvement, and corrections are recommended in present disclosure, so the modification, improvement, and the amendment remain in the spirit and scope of the exemplary embodiment of the present disclosure.

At the same time, present disclosure uses specific words to describe the embodiments of the present disclosure. As “one embodiment”, “an embodiment”, and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters used in the specification and claims are approximate values, and the approximation may change according to the characteristics required by the individual embodiments. In some embodiments, the numerical parameter should consider the prescribed effective digits and adopt a general digit retention method. Although in some embodiments, the numerical fields and parameters used to confirm the breadth of its range are approximate values, in specific embodiments, such numerical values are set as accurately as possible within the feasible range.

With respect to each patent, patent application, patent application disclosure, and other material cited in the present disclosure, such as articles, books, manuals, publications, documents, etc., the entire contents thereof are hereby incorporated by reference into the present disclosure. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those described in the present disclosure, the descriptions, definitions, and/or use of terms in the present disclosure shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing a gas pipeline corridor robot based on regulatory Internet of Things (IoT), the method being performed by a management platform of a gas company of an IoT system for managing the gas pipeline corridor robot based on the regulatory IoT, comprising:
obtaining, through the management platform of the gas company, corridor environmental data from a sensing network platform of the gas company;
determining, through the management platform of the gas company, a robot inspection command based on the corridor environmental data;
sending, through the management platform of the gas company, the robot inspection command to a gas equipment object platform via the sensing network platform of the gas company to control a maintenance robot to operate along an operation track;
obtaining inspection data of the maintenance robot, through the management platform of the gas company;
determining, through the management platform of the gas company, doubtful data based on the inspection data;
in response to the presence of the doubtful data, transmitting, through the management platform of the gas company, the doubtful data to a gas customer service platform for manual re-inspection; and
obtaining a manual re-inspection result and uploading the manual re-inspection result to a government supervision management platform via a government supervision sensing network platform, through the management platform of the gas company.

2. The method of claim 1, the IoT system for managing the gas pipeline corridor robot based on the regulatory IoT includes a government supervision service platform, the government supervision management platform, the government supervision sensing network platform, the gas customer service platform, a government supervision object platform, the sensing network platform of the gas company, and the gas equipment object platform; and
the government supervision service platform includes a government safety supervision service platform; the government supervision management platform includes a government safety supervision management platform; the government supervision sensing network platform includes a government safety supervision sensor network platform, and the government supervision object platform includes the management platform of the gas company.

3. The method of claim 2, wherein the gas equipment object platform includes a pipeline corridor monitoring device, the maintenance robot, the operation track, and a processor;
the pipeline corridor monitoring device distributed and deployed within the pipeline corridor is configured to:
monitor and collect the corridor environmental data;
upload the corridor environmental data to the management platform of the gas company based on the sensing network platform of the gas company;
the maintenance robot is configured to:
perform an inspection along the operation track and obtain the inspection data based on the robot inspection command; and
the processor is configured to:
upload the corridor environmental data collected by the pipeline corridor monitoring device to the sensing network platform of the gas company;
control the maintenance robot to operate along the operation track based on the robot inspection command; and
obtain the inspection data of the maintenance robot and upload the inspection data to the sensing network platform of the gas company, and further upload the inspection data to the government supervision sensing network platform based on the government supervision object platform.

4. The method of claim 1, wherein the inspection data includes one or more pieces of inspection sub-data, a pipeline corridor region corresponding to each of the one or more pieces of inspection sub-data, and environmental monitoring data;
the doubtful data is related to a pipeline corridor complexity;
the determining, through the management platform of the gas company, the doubtful data based on the inspection data includes:
determining, through the management platform of the gas company, the doubtful data based on the inspection data and the pipeline corridor complexity.

5. The method of claim 4, wherein the doubtful data is further related to a maintenance record of the pipeline corridor monitoring device;
the determining, through the management platform of the gas company, the doubtful data based on the inspection data includes:
determining, through the management platform of the gas company, an anomaly monitoring device based on the environmental monitoring data and the maintenance record;
uploading, through the management platform of the gas company, the anomaly monitoring device to the gas customer service platform; and
in response to obtaining feedback information of the anomaly monitoring device from the gas customer service platform, determining, through the management platform of the gas company, the doubtful data based on the one or more pieces of inspection sub-data, the pipeline corridor region corresponding to each of the one or more pieces of inspection sub-data, the pipeline corridor complexity, and the feedback information.

6. The method of claim 5, wherein the doubtful data is further related to a corridor environment dataset, the corridor environment dataset includes corridor environmental data from one or more target monitoring nodes;
the determining, through the management platform of the gas company, the doubtful data based on the one or more pieces of inspection sub-data, the pipeline corridor region corresponding to each of the one or more pieces of inspection sub-data, the pipeline corridor complexity, and the feedback information includes:
determining, the management platform of the gas company, the doubtful data through a data determination model based on the corridor environment dataset, the one or more pieces of inspection sub-data, the pipeline corridor region corresponding to each of the one or more pieces of inspection sub-data, the pipeline corridor complexity, and the feedback information, the data determination model being a machine learning model.

7. The method of claim 4, wherein the doubtful data is further related to a pipeline corridor use hazard.

8. The method of claim 1, further comprising:
in response to the absence of the doubtful data, determining, through the management platform of the gas company, a pipeline corridor use hazard based on the inspection data;
uploading, through the management platform of the gas company, the pipeline corridor use hazard to the government supervision management platform via the government supervision sensing network platform; and
adjusting, through the management platform of the gas company, a replacement cycle of a pipeline corridor spare consumable based on the pipeline corridor use hazard; wherein the pipeline corridor spare consumable includes at least one of an emergency supply, a maintenance consumable, and a rescue consumable.

9. The method of claim 8, wherein the inspection data further includes image data, sound data;
the determining, through the management platform of the gas company, the pipeline corridor use hazard based on the inspection data includes:
determining, through the management platform of the gas company, the pipeline corridor use hazard based on the image data and the sound data.

10. The method of claim 9, wherein the determining, through the management platform of the gas company, the pipeline corridor use hazard based on the image data and the sound data includes:
determining, through the management platform of the gas company, the pipeline corridor use hazard through a hazard determination model based on the image data and the sound data; the hazard determination model being a machine learning model.

11. The method of claim 8, wherein the adjusting, through the management platform of the gas company, the replacement cycle of a pipeline corridor spare consumable based on the pipeline corridor use hazard includes:
determining, through the management platform of the gas company, a spare consumable risk based on the pipeline corridor use hazard; and
adjusting, through the management platform of the gas company, the replacement cycle of the pipeline corridor spare consumable based on a preset replacement cycle of the pipeline corridor spare consumable and the spare consumable risk.

12. The method of claim 11, wherein the spare consumable risk is further related to the doubtful data;
the determining, through the management platform of the gas company, the spare consumable risk based on the pipeline corridor use hazard, includes:
in response to the absence of the doubtful data in the pipeline corridor region in which the pipeline corridor spare consumable is located, determining, through the management platform of the gas company, the spare consumable risk based on the pipeline corridor use hazard.

13. The method of claim 11, the determining, through the management platform of the gas company, the spare consumable risk based on the pipeline corridor use hazard includes:
in response to the presence of the doubtful data in the pipeline corridor region in which the pipeline corridor spare consumable is located, obtaining, through the management platform of the gas company, the manual re-inspection result from the gas customer service platform; and
determining, through the management platform of the gas company, the spare consumable risk based on the manual re-inspection result and the pipeline corridor use hazard.

14. The method of claim 11, the adjusting, through the management platform of the gas company, the replacement cycle of the pipeline corridor spare consumable based on the preset replacement cycle of the pipeline corridor spare consumable and the spare consumable risk includes:
determining, through the management platform of the gas company, a first adjustment amount of the replacement cycle based on the spare consumable risk;
determining, through the management platform of the gas company, a second adjustment amount of the replacement cycle based on the preset replacement cycle; and
adjusting, through the management platform of the gas company, the replacement cycle of the pipeline corridor spare consumable based on the first adjustment amount and the second adjustment amount.

15. An IoT system for managing a gas pipeline corridor robot based on regulatory IoT, comprising a government supervision service platform, a government supervision management platform, a government supervision sensing network platform, a gas customer service platform, a government supervision object platform, a sensing network platform of the gas company, and a gas equipment object platform;
the government supervision service platform includes a government safety supervision service platform;
the government supervision management platform includes a government safety supervision management platform;
the government supervision sensing network platform includes a government safety supervision sensor network platform;
the government supervision object platform includes the management platform of the gas company;
the government supervision sensing network platform is configured to interact with the government supervision management platform and the government supervision object platform;
the sensing network platform of the gas company is configured to interact with the management platform of the gas company and the government supervision object platform;
the gas customer service platform is configured to interact with the management platform of the gas company;
the management platform of the gas company is configured to:
obtain, through the management platform of the gas company, corridor environmental data from a sensing network platform of the gas company;
determine, through the management platform of the gas company, a robot inspection command based on the corridor environmental data;
send, through the management platform of the gas company, the robot inspection command to a gas equipment object platform via the sensing network platform of the gas company to control a maintenance robot to operate along an operation track;
obtain inspection data of the maintenance robot, through the management platform of the gas company;
determine, through the management platform of the gas company, doubtful data based on the inspection data;
in response to the presence of the doubtful data, transmit, through the management platform of the gas company, the doubtful data to a gas customer service platform for manual re-inspection; and
obtain a manual re-inspection result and uploading the manual re-inspection result to a government supervision management platform via a government supervision sensing network platform, through the management platform of the gas company.

16. The system of claim 15, wherein the gas equipment object platform includes a pipeline corridor monitoring device, the maintenance robot, the operation track, and a processor;
the pipeline corridor monitoring device distributed and deployed within the pipeline corridor is configured to:
monitor and collect the corridor environmental data;
upload the corridor environmental data to the management platform of the gas company based on the sensing network platform of the gas company;
the maintenance robot is configured to; and
perform an inspection along the operation track and obtain the inspection data based on the robot inspection command;
the processor is configured as:
upload the corridor environmental data collected by the pipeline corridor monitoring device to the sensing network platform of the gas company;
control the maintenance robot to operate along the operation track based on the robot inspection command; and
obtain the inspection data of the maintenance robot and upload the inspection data to the sensing network platform of the gas company, and further upload the inspection data to the government supervision sensing network platform based on the government supervision object platform.

17. The system of claim 15, the inspection data includes one or more pieces of inspection sub-data, a pipeline corridor region corresponding to each of the one or more pieces of inspection sub-data, and environmental monitoring data;
the doubtful data is related to a pipeline corridor complexity;
the management platform of the gas company is further configured to:
determine the doubtful data based on the inspection data and the pipeline corridor complexity.

18. The system of claim 15, the management platform of the gas company is further configured to:
in response to the absence of the doubtful data, determining a pipeline corridor use hazard based on the inspection data;
uploading the pipeline corridor use hazard to the government supervision management platform via the government supervision sensing network platform; and
adjusting a replacement cycle of a pipeline corridor spare consumable based on the pipeline corridor use hazard; wherein the pipeline corridor spare consumable includes at least one of an emergency supply, a maintenance consumable, and a rescue consumable.

19. The system according to claim 18, wherein the management platform of the gas company being further configured to:
determine a spare consumable risk based on the pipeline corridor use hazard; and
adjust the replacement cycle of the pipeline corridor spare consumable based on a preset replacement cycle of the pipeline corridor spare consumable and the spare consumable risk.

20. A non-transitory computer-readable storage medium, comprising a set of instructions, wherein when a computer reads the computer instructions in the storage medium, a method for managing a gas pipeline corridor robot based on regulatory IoT of claim 1 is implemented.
